(19) United States
(12) Patent Application Publication
(10) Pub. No.: US 2013/0177745 A1
(43) Pub. Date: Jul. 11, 2013

(54) DEFORMED SHEET MATERIAL

(71) Applicants: Igor Lvovich Berezovsky, Saint-Petersburg (RU); Vladimir Pavlovich Lobko, Ybileiny (RU); Boris Borisovich Nikitin, Saint-Petersburg (RU); Nikolay Olegovich Revenko, Saint-Petersburg (RU); Andrey Igorevich Kouzov, Saint-Petersburg (RU); Aleksey Anatolievich Zuev, Saint-Petersburg (RU)

(72) Inventors: Igor Lvovich Berezovsky, Saint-Petersburg (RU); Vladimir Pavlovich Lobko, Ybileiny (RU); Boris Borisovich Nikitin, Saint-Petersburg (RU); Nikolay Olegovich Revenko, Saint-Petersburg (RU); Andrey Igorevich Kouzov, Saint-Petersburg (RU); Aleksey Anatolievich Zuev, Saint-Petersburg (RU)

(21) Appl. No.: 13/642,780

(22) PCT Filed: Apr. 20, 2010
(86) PCT No.: PCT/RU10/00192

§ 371 Date: Feb. 28, 2013

(51) Int. Cl. B44F 99/00

(52) U.S. Cl. CPC B44F 99/00
USPC 428/174

(57) ABSTRACT

The invention relates to the field of deformed sheet materials, in particular of metal, plastic, glass, cardboard, paper, wood, laminated material and composite material, and articles manufactured with the use thereof. The sheet material is made such that the boundary of its transverse cross section and the boundary of its longitudinal cross section, in at least one of the sections, are made in the form of elements, differing in length, of different hyperbolas and/or ellipses with different values of eccentricities and focal parameters, and additional contain a section made in the form of elements, differing in length, of different hyperbolas and/or ellipses with different values of eccentricities and focal parameters, wherein the above-mentioned section of the boundary of the transverse section and the section of the boundary of the longitudinal cross section intersect. The technical result of the invention is the possibility of improving the reliability of identification and protection against counterfeiting of sheet materials in combination with convenience of identification due to simplifying the design of the working surface of tools.

### FIELD OF THE INVENTION

The invention relates to production of deformed sheet materials, in particular of metal, plastic, glass, cardboard, paper, wood, laminated material and composite material, and can be applied in designing and manufacture of various products using deformed sheet materials, such as sheet and profiled rolled products, corrugated sheets, parts and casings of various products, e.g. vehicles (fenders, hoods, roofs and other components of cars), household appliances and computers (parts of refrigerators, computer cases, etc.), packaging (boxes, cartons, packing cases and other containers), building materials and structures (tiles, walls in the ground, molded glass, etc.), and so on, when importing or exporting deformed sheet materials, as well as the storage and sale of deformed sheet materials.

### BACKGROUND ART

A conventional sheet material is made so that the boundary of its transverse section, in at least one segment, forms a conic section element (Abstract of RU Pat. No. 36274, Sheet Material, published 10.03.2004).

The combination of features of the conventional sheet material is similar to features of the present invention, in particular, a sheet material is made so that the boundary of its transverse section, in at least one segment, forms a conic section element.

The problem of the conventional sheet material is its rather low protection against counterfeit.

Another conventional sheet material is made so that the boundary of its transverse section, in at least one segment, forms a conic section element. The patent discloses a car fender formed of a deformed sheet material (U.S. Pat. No. 5,149,169).

The combination of features of the conventional sheet material is similar to features of the present invention, in particular, a deformed sheet material is made so that the boundary of its transverse section, in at least one segment, forms a conic section element.

Disadvantages of the sheet material include difficulty of its identification when in use and rather low protection against counterfeit.

The closest prior art is a deformed sheet material made so that the boundary of its transverse section is formed, in at least one segment, as a conic section element and the boundary of its longitudinal section is formed, in at least one segment, as a conical section element (U.S. Pat. No. 4,687,217). This combination of features is similar to features of the present invention.

The closest prior art has the following disadvantages. Identification of the material is rather difficult when in use due to the fact that the boundary of the transverse section is formed by straight lines and circle elements, and the boundary of the longitudinal section is formed by straight lines and circle elements, which are commonly used in production of sheet materials by a great number of manufacturers.

The closest prior art has rather low protection against counterfeit when it is produced due to the fact that segments of the transverse section boundary are formed by circle elements and straight lines, and segments of the longitudinal section boundary are formed by straight lines and circle elements, which are commonly used in production of sheet materials by a great number manufacturers.

### SUMMARY OF THE INVENTION

The object of the invention is to provide considerable improvement in protection of deformed sheet materials against counterfeit.

The object is accomplished in a deformed sheet material made so that the boundary of its transverse section, in at least one segment, is formed as a conic section element and the boundary of its longitudinal section, in at least one segment, is formed as a conic section element, said deformed sheet material being distinguished from the closest prior art in that said segment of the transverse section boundary of the deformed sheet material and said segment of the longitudinal section boundary of the deformed sheet material are selected from the group including the following:

a) said segment of the transverse section boundary of the deformed sheet material and said segment of the longitudinal section boundary of the deformed sheet material are formed as different length elements of different ellipses with different values of eccentricities and focal parameters, and said segment of the transverse section boundary and said segment of the longitudinal section boundary intersect;

(b) said segment of the transverse section boundary of the deformed sheet material and said segment of the longitudinal section boundary of the deformed sheet material are formed as different length elements of different hyperbolas with different values of eccentricities and focal parameters, and said segment of the transverse section boundary and said segment of the longitudinal section boundary intersect;

(c) said transverse section boundary of the deformed sheet material further comprises a segment formed as different length elements of different ellipses with different values of eccentricities and focal parameters, and said longitudinal section boundary of the deformed sheet material further comprises a segment formed as different length elements of different ellipses with different values of eccentricities and focal parameters, and said segment of the transverse section boundary and said segment of the longitudinal section boundary intersect;

(d) said transverse section boundary of the deformed sheet material further comprises a segment formed as different length elements of different hyperbolas with different values of eccentricities and focal parameters, and said longitudinal section boundary of the deformed sheet material further comprises a segment formed as different length elements of different hyperbolas with different values of eccentricities and focal parameters, and said segment of the transverse section boundary and said segment of the longitudinal section boundary intersect;

(e) said transverse section boundary of the deformed sheet material further comprises a segment formed as different length elements of hyperbola and ellipse, and said longitudinal section boundary of the deformed sheet material further comprises a segment formed as different length elements of hyperbola and ellipse, and said segment of the transverse section boundary and said segment of the longitudinal section boundary intersect.

In an embodiment, the sheet material has a thinning at said segment of the transverse section boundary.

In an embodiment, the sheet material has a thinning at said segment of the longitudinal section boundary.

In an embodiment, the sheet material may be a layered material.

The invention is designated for production of variety of devices (products) using deformed sheet materials, such as sheet and profiled rolled products, corrugated sheets, parts and casings of vehicles (fenders, hoods, roofs and other components of cars), household appliances and computers (parts of refrigerators, computer cases, etc.), packaging (boxes, cartons, packing cases and other containers), building materials and structures (tiles, walls in the ground, molded glass, etc.).

The invention offers the following technical advantages:
it considerably improves (increases convenience and reliability) identification of deformed sheet materials when in use owing to forming a segment of the transverse section boundary and a segment of the longitudinal section boundary as conic section elements and exclusion of circle elements and straight lines, as commonly used in production of sheet materials, when forming said boundary section segments;
it considerably improves protection of deformed sheet materials against counterfeit when they are produced owing to making a segment of the transverse section boundary and a segment of the longitudinal section boundary in the form of various conic section elements, which are identifiers of the manufacturer of the sheet materials, and exclusion of circle elements and straight lines, as commonly used in production of sheet materials, when forming said boundary section segments.

To simplify the description, a deformed sheet material will be hereafter also referred to as “sheet material”.

Further ten embodiments of a deformed sheet material developing the invention will be described below.

A sheet material can be made so that it further comprises in the same transverse section a segment of the transverse section boundary and in the same longitudinal section a segment of the longitudinal section boundary, the segments being formed as different length elements of various ellipses with different values of eccentricities and focal parameters.

A sheet material can be made so that it further comprises in the same transverse section a segment of the transverse section boundary and in the same longitudinal section a segment of the longitudinal section boundary, the segments being formed as different length elements of various hyperbolas with different values of eccentricities and focal parameters.

A sheet material can be made so that it further comprises in the same transverse section a segment of the transverse section boundary, the segment being formed as different length elements of various ellipses with different values of eccentricities and focal parameters, and in the same longitudinal section it further comprises a segment of the longitudinal section boundary, the segment being formed as different length elements of various ellipses with different values of eccentricities and focal parameters.

A sheet material can be made so that it further comprises in the same transverse section a segment of the transverse section boundary, the segment being formed as different-length elements of various hyperbolas with different values of eccentricities and focal parameters, and in the same longitudinal section a segment of the longitudinal section boundary, the segment being formed as different length elements of various hyperbolas with different values of eccentricities and focal parameters.

A sheet material can be made so that it further comprises in the same transverse section a segment of the transverse section boundary, the segment being formed as different length elements of hyperbola and ellipse, and in the same longitudinal section a segment of the longitudinal section boundary, the segment being formed as different length elements of hyperbola and ellipse.

A sheet material can be made so that it further comprises in another transverse section a segment of the transverse section boundary and in another longitudinal section a segment of the longitudinal section boundary, the segments of the transverse and longitudinal section boundaries being formed as different length elements of various ellipses with different values of eccentricity and focal parameters.

A sheet material can be made so that it further comprises in another transverse section a segment of the transverse section boundary, and in another longitudinal section a segment of the longitudinal section boundary, the segments of the transverse and longitudinal section boundaries being formed as different length elements of various hyperbolas with different values of eccentricity and focal parameters.

A sheet material can be made so that it further comprises in another transverse section a segment of the transverse section boundary, the segment being formed as different length elements of various ellipses with different values of eccentricities and focal parameters, and in another longitudinal section a segment of the longitudinal section boundary, the segment being formed as different length elements of various ellipses with different values of eccentricities and focal parameters.

A sheet material can be made so that it further comprises in another transverse section a segment of the transverse section boundary, the segment being formed as different length elements of various hyperbolas with different values of eccentricities and focal parameters, and in another longitudinal section a segment of the longitudinal section boundary, the segment being formed as different length elements of various hyperbolas with different values of eccentricities and focal parameters.

A sheet material can be made so that it further comprises in another transverse section a segment of the transverse section boundary, the segment being formed as different-length elements of hyperbola and ellipse, and in another longitudinal section a segment of the longitudinal section boundary, the segment being formed as different-length elements of ellipse and hyperbola.

Explanation of terms used to describe features of the invention.

“Eccentricity” and “focal parameter” completely define a conic section (hyperbola, parabola and ellipse).

“Segment of the transverse section boundary” refers to a part of the boundary of a transverse section. Length of the segment is less than length of the entire transverse section boundary.

“Segment of the longitudinal section boundary” refers to a part of the boundary of a longitudinal section. Length of the segment is less than length of the entire longitudinal section boundary.

“Longitudinal section” is a section extending or lying along the length of something.

“Lengthwise” means along the length of something.

“Transverse section” is a section extending or lying across something.

“Across” means across the width of something.

Transverse section is taken at the right angle with respect to the longitudinal section.

Use of values of eccentricities and focal parameters as identifying features of sheet materials shall allow the capabilities of conic sections as identifiers of the sheet material manufacturers to be used to the maximum extent possible.

In case the aforementioned segments of section boundaries are formed of ellipse elements, the following conditions should be preferably fulfilled when producing the sheet materials:
the ratio of length of the larger element of ellipse to length of the smaller element of ellipse measures from 1.001 to 1000;
the ratio of the larger value of eccentricity of ellipse to the smaller value of eccentricity of ellipse measures from 1.001 to 1000000;
the ratio of the larger value of focal parameter of the ellipse to the smaller value of focal parameter of the ellipse measures from 1.001 to 1000000. These conditions shall simplify production of sheet materials and their identification.

In case the aforementioned segments of section boundaries are formed by hyperbola elements, the following conditions should be preferably fulfilled when producing the sheet materials:
the ratio of length of the larger element of hyperbola to length of the smaller element of hyperbola measures from 1.001 to 1000;
the ratio of the larger value of eccentricity of hyperbola to the smaller value of eccentricity of hyperbola measures from 1.001 to 1000000;
the ratio of the larger value of focal parameter of hyperbola to the smaller value of focal parameter of hyperbola measures from 1.001 to 1000000. These conditions shall also simplify production of sheet materials and their identification.

In case the aforementioned segment of (transverse or longitudinal) section boundary is formed by elements of hyperbola and ellipse, the following condition should be preferably fulfilled when producing the sheet materials:
the ratio of length of the larger element to length of the smaller element measures from 1.001 to 1000.

The inventive deformed sheet material offers higher protection against counterfeit, simplifies and reduces the cost of the manufacturer identification, and facilitates disposal.

Life cycle of sheet materials comprises three stages: production, usage and disposal. The following discloses in detail the stages in terms of identifiers and identification.

First Stage. Production of Sheet Materials with Identifiers

Identifier or identifiers are introduced during the manufacturing process of sheet materials or after.

“Identifier” refers to an attribute used to identify an identifiable object, in particular, a sheet material produced by a certain manufacturer at a certain place of production. Identifier or a set of identifiers provides unambiguous identification of the manufacturer, and, with the manufacturer known, conditions and peculiarities of production, materials and means of manufacture of the sheet material shall be defined. There may be several, tens, hundreds, thousands, or more identifiers.

The more identifiers introduced into the structure of sheet material, the more difficult it is to counterfeit the product of this sheet material.

Currently used identifiers include:
stamp or seal affixed on the surface of a sheet material. A trademark may be affixed as an imprint. Appearance of a label glued on a sheet material and information on the label;
color or color shade of the sheet material;
type of raw material used for production of the sheet material, unique additives and fillers of all kinds;
design features of sheet materials, in particular, irregularly shaped surface (irregular form of a section).

Design features are input by appliances and tools used to deform the sheet material at the manufacturer's works. Deformation can be executed, in particular, by rolling and/or stamping and/or bending.

Design features include:
irregular shape of sheet material (or an element of sheet material), in particular, alternating projections and recesses made in the section in the form of conic section elements;
specific values of rounding radii (that are not used by any other manufacturers), specific values of body lengths (that are not used by other manufacturers), etc;
type and class of surface treatment, mate surfaces, surfaces with high reflective properties, surfaces treated with unique instrument;
use of curves or a set of second-order curves for forming the section boundary of the sheet material. The more sophisticated the set of curves, the more reliable the identification, and the more difficult it is to counterfeit the sheet material of the manufacturer. References [1-20] disclose sections of various devices having sophisticated configurations.

The invention provides for exclusion of straight lines and circle elements when forming predetermined section boundaries of sheet materials. Straight lines and circle elements are nowadays commonly used by manufacturers for formation of section boundaries of sheet materials. Exclusion of straight lines and circle elements when forming predetermined section boundaries of sheet materials and use of elements of hyperbolas or ellipses instead is an effective identifier, i.e. a distinctive feature of the manufacturer and producer of sheet materials.

Second Stage. Use of Sheet Materials

Use of sheet materials starts with incoming inspection at an enterprise using the sheet materials, for example, for manufacture of car fenders. Identification of the sheet material is performed in the process of incoming inspection. The main task of the incoming inspection is to detect rejected sheet materials, sheet materials with defects, and counterfeit sheet materials (e.g. sheet materials of back-yard production made of low-quality raw materials, but reminding a sheet material of a known manufacturer in the form).

Use of counterfeit, substandard sheet materials in the automotive industry may lead to increased deaths on the roads in accidents and enormous economic and moral damage to the manufacturers of automobiles.

Use of counterfeit, substandard sheet materials in other industries may also lead to victims, economic and moral damage to the manufacturer of products using the sheet materials.

“Identification” shall mean matching of an identifiable object (article) with its image (identification feature), in our case, determining whether a certain sample of the sheet material was produced by a certain manufacturer according to the identifier of the manufacturer introduced into the structure of the sheet material body in the course of its production.

Instruments and devices, such as coordinate measuring machines, microscopes with camera function, etc, can be used for identification of the inventive sheet material. A mathematical method disclosed in section “Embodiment of the invention” can be used for processing the results of measurements.

In use sheet materials are exposed to load action.

In case the sheet material does not meet quality standard (e.g. it is counterfeit), it can be destroyed in the process of loading.

Any claims related to the destruction of sheet material shall be addressed to the manufacturer. The manufacturer or an appointed committee shall perform identification of the destroyed sheet material and determine whether a certain sample of the destroyed sheet material was produced by this manufacturer or it was made at another factory. Payer of damages to the consumer of the sheet material shall be defined according to the results of the identification.

Third Stage. Disposal of Sheet Material

Sheet materials shall be disposed by means of destruction under press and grinding. Raw material obtained after destruction and grinding shall be delivered to the manufacturer for production of new sheet materials.

Currently information about the sheet material manufacturer is usually contained in a label, tag, certificate or encoded into impress (stamp or bar code) affixed onto the surface of the sheet material. However, the tag, label, certificate or impress can be simply counterfeited. It is more difficult to counterfeit a mark or information produced by a laser under a surface layer (coating) of a sheet material (for example, car component) using a technique described in Abstract of RU Pat. No. 2124988, published 20 Jan. 1999. Such mark is invisible to an unaided eye. It can be seen in polarized light only. Over-sophistication and high cost of equipment is a disadvantage of the technique.

Studies performed in the course of development of the present invention have shown that it is difficult to counterfeit peculiarities of the shape of the sheet materials, introduced simultaneously into longitudinal and transverse sections of the sheet materials with accessories and tools used for deformation of the sheet material by the manufacturer. And this method of protection of sheet materials against counterfeit is now the most effective and promising in terms of further improvement.

The present invention offers considerable increase in protection of deformed sheet materials against counterfeit when they are produced owing to making a segment of the transverse section boundary and a segment of the longitudinal section boundary in the form of various conic section elements that are identifiers of the sheet material manufacturer, i.e. features for distinction of the sheet materials produced at this certain factory from sheet materials produced at any other production facility. Therewith, the total length of segments of the boundary sections with the identifiers may be substantially increased as compared to the situation when the identifier is located on the transverse section boundary only.

Identifiers located only on the transverse section boundary are described in Abstract of RU Pat. No. 2266851, published 27.12.2005 (publication date of Application 20.12.2004).

The present invention elaborates upon the theme of improvement of production of sheet materials with irregular shape of surface and introduction of an identifier or identifiers in the form of different length conic section elements with different characteristics (parameters), in particular, with different eccentricities and focal parameters, into the structure of sheet materials, in particular, in both longitudinal and transverse section of sheet material.

It is preferable to introduce the identifier into the shape of transverse and longitudinal section or the shape of boundary of transverse and longitudinal sections of sheet material, as long as the section boundary is specified in the process of shaping operations when producing the deformed sheet materials. It is preferable to form the identifier as a combination of various elements of ellipses, or hyperbolas, or ellipses and hyperbolas, therewith excluding straight lines and circle elements as commonly used nowadays in production of sheet materials. The fact that it is difficult to produce and identify the identifier in form of a circle element will be demonstrated below.

Improved convenience and reliability of identification of sheet materials when in use is achieved due to provision of identifiers on the sheet material surface both on the transverse section boundary and the longitudinal section boundary in the form of various conic section elements.

Ellipse is a conic section and its eccentricity (in polar coordinates) may be, for example, from 0.00001 to 0.99999 (i.e. values that are larger than zero, but smaller than one). Hyperbola is a conic section and its eccentricity may be, for example, from 1.00001 to 1000000 (i.e. values that are larger than one). Parabola is a conic section and its eccentricity equals to 1. Circle is a conic section as well and its eccentricity equals to 0.

When introducing an identifier (for example, into a press die (mould) by a computer-controlled milling machine) a minor inaccuracy is always possible. For example, the process of introducing a circle element into the transverse section may be implemented with 1% inaccuracy. Then the eccentricity may equal to 0.01 at identification of the sheet material (performance of measurements, identification of curves and calculation of eccentricity). But this value is larger than 0, and the figure at the transverse section is identified as an ellipse. The process of introduction of a parabola element into the transverse section may be implemented with 1% inaccuracy as well. Then the eccentricity may equal to 0.99 at identification of the sheet material. But this value is smaller than 1, and the figure at the transverse section is identified as an ellipse.

To avoid such inaccuracy and increase efficiency of identification process, it is preferable to use only elements or combinations of elements of ellipses and hyperbolas for identification of sheet materials, therewith the eccentricity of ellipse should be set in a range, for example, from 0.01 (far away from 0 value) up to, for example, 0.99, and for hyperbola from 1.01 and higher.

Currently available coordinate measuring machines (e.g. QM-M333, EGX-30, MINITRICOORD, TRICOORD) allow for making measurements of objects with maximum size up to 2500 mm and minimum size 10 mm.

In case of commercial implementation of the invention every plant or factory producing sheet materials shall be assigned a unique combination of elements of various ellipses and hyperbolas with different values of eccentricities and focal parameters in predetermined places on transverse section boundary and longitudinal section boundary.

Thus, a considerable improvement (increase in convenience and reliability) of identification of the sheet material when in use is attained due to making a segment of transverse section boundary and a segment of longitudinal section boundary in the form of conic section elements and exclusion of circle elements, as commonly used in production of sheet materials, when forming these section boundary segments.

Simplification of production of deformed sheet materials with irregular shaped body is achieved by exclusion of circle elements when forming longitudinal and transverse sections of sheet materials (or, in other words, outlines of the sheet materials).

Current techniques of manufacturing deformed sheet materials assume use of moulds and forming rolls. Working surfaces of moulds and working rolls are made with transverse section boundaries formed by circle elements and longitudinal section boundaries formed by straight lines and circle elements. Such moulds can be manufactured at computer numerically controlled (CNC) machines with installed software suitable for operation with geometrical figures in form of circles.

Equipment used for manufacture of moulds and forming rolls should have the highest accuracy rate. High-precision CNC lathe machine 1I611PMFZ can be used for production of forming rolls. This machine is designed for processing surfaces of parts like bodies of revolution with stepped and curved profile of various complexities. The machine is equipped with a CNC, synchronous drives, feed drive motors and Lenze variable frequency driver, and electric-powered drive of the turret. The machine has accuracy rating “P” according to Russian State Standard GOST 8-82. Specifications: maximum diameter of workpiece above toolhead—125 mm, maximum length of workpiece—500 mm, increment of lengthwise and edgewise movement of toolhead—0.001 mm. A version of the machine with accuracy rating “B” according to Russia State Standard GOST 8-82 is also available.

Widely used CNC 6M612F11 milling and boring machine may be used for manufacture of moulds for sheet materials that do not have elements of circles in transverse and longitudinal sections, but have only elements of ellipses and hyperbolas at transverse and longitudinal sections. This machine is designed for processing surfaces of parts with stepped and curved profile of various complexities including elliptical and hyperbolical profiles.

PNC 300 3D milling machine may be used to create sophisticated surfaces of moulds as well. The machine comprises a computer for 3D simulation of the processed surface and a milling unit for fast production of the simulated moulds. This machine offers maximum surface processing speed 3.6 m/min in X and Y directions and 1.8 m/min in Z direction, programmable resolution 0.01 mm/step and mechanical resolution of 0.00125 mm/step. In practice, the machine has proved its high capabilities for reproducing any curved surfaces in metallic and other (plastic, glass, wooden) materials.

Time for production of a mould with elements of hyperbolas and ellipses at transverse and longitudinal sections using this machine is substantially shorter than time for production of a mould with circles at sections (verified experimentally).

The above machines are used in the Russian Federation. Any other machines with similar characteristics may be used for practicing the invention in the United States and the European Union members.

Therefore, making segments of section boundaries in the form of circles leads to complication of the sheet material manufacturing process. Elements of circles (as well as parabolas) should not be used as identifiers as long as manufacturing errors cause errors in identification.

When manufacturing sheet materials according to the present invention, structural orientation of strength properties of the sheet materials is provided in longitudinal and transverse section, which simplifies the process of disposal of sheet materials by means of pressing. When disposed of in a press, the sheet material is oriented so that the compressive effect of the press occurs in a plane with the lowest compressive load resistance of the sheet. Making section boundaries in the form of conical section elements leads to local thinning or thickening of the sheet material wall. The place of wall thinning is the place where compressive force should be applied in the disposal. Destruction of the sheet material is most probable in the place of thinning. The place of wall thickening is as well the place where compressive force should be applied in disposal, since the compressive force is concentrated at that exact place.

Making segments of section boundaries in the form of elements of ellipses and hyperbolas results in that the section shall have an axis (axis A) relative to which the moment of inertia of the section at bending is maximum, and an axis (axis B) relative to which the moment of inertia of the section at bending is minimum In the process of disposal of the sheet materials, the force shall be applied to the sheet material in a direction parallel to axis A and perpendicular to axis B. In this case the sheet material offers minimal bending resistance at this section, thereby reducing the force for destruction of the sheet material and power consumption for its disposal.

### BRIEF DESCRIPTION OF DRAWINGS

FIG. 1 shows a general view of a car fender made in the form of a deformed sheet material.

FIG. 2 shows detail drawing I.

FIG. 3 shows a longitudinal section of the sheet material in the area shown in detail drawing I.

FIG. 4 is a transverse section of the sheet material in the area shown in detail drawing I.

FIG. 5 shows detail drawing II.

FIG. 6 is a longitudinal section of the sheet material in the area shown in detail drawing II.

FIG. 7 shows a transverse section of the sheet material in the area shown in detail drawing II.

FIG. 8 shows detail drawing III.

FIG. 9 shows a longitudinal section of the sheet material in the area shown in detail drawing III.

FIG. 10 shows a transverse section of the sheet material in the area shown in detail drawing III.

FIG. 11 shows detail drawing IV.

FIG. 12 is a longitudinal section of the sheet material in the area shown in detail drawing IV.

FIG. 13 shows a transverse section of the sheet material in the area shown in detail drawing IV.

FIG. 14 shows detail drawing V.

FIG. 15 shows a longitudinal section of the sheet material in the area shown in detail drawing V.

FIG. 16 shows a transverse section of the sheet material in the area shown in detail drawing V.

### DESCRIPTION OF EMBODIMENTS OF THE INVENTION

As an example of the invention consider a car fender made in the form of a deformed sheet material.

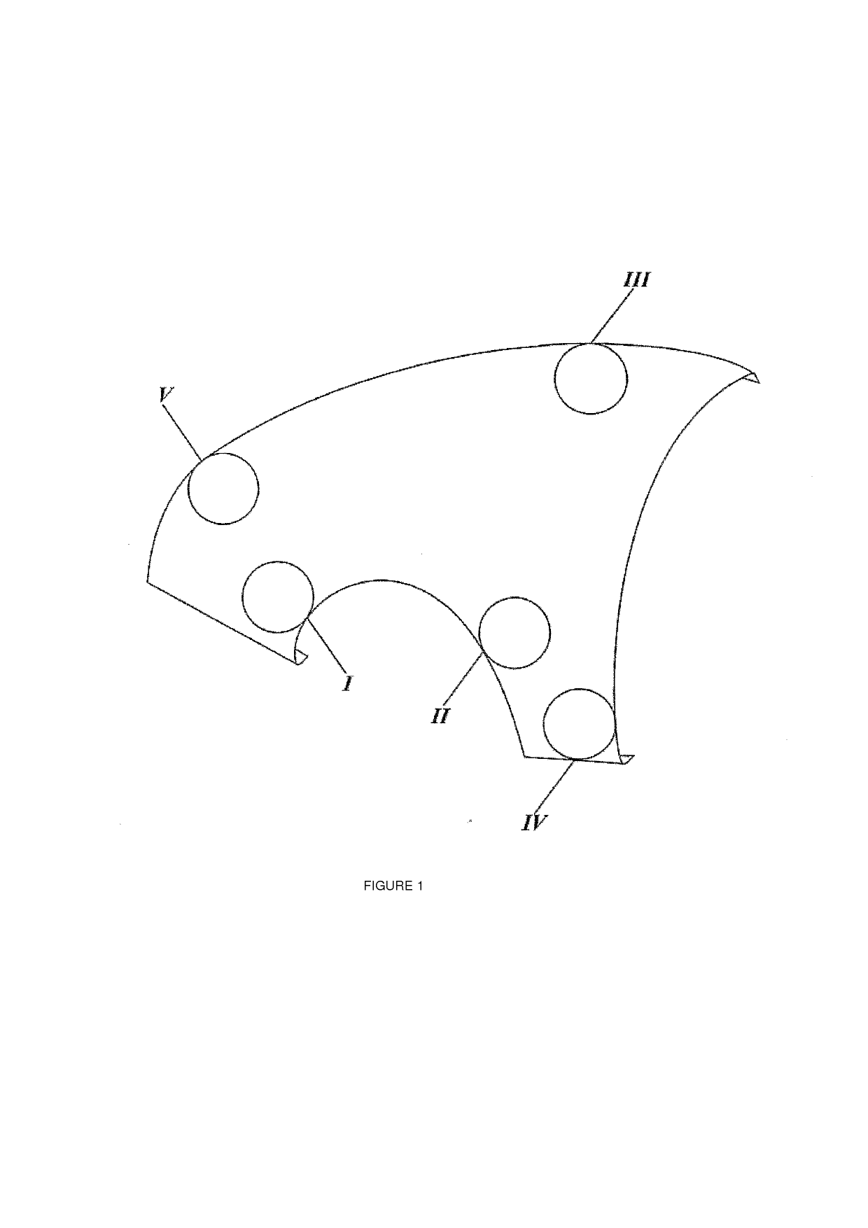

FIG. 1 shows a deformed sheet material (car fender). Five areas are marked out on the sheet material. These areas are denoted as detail drawings I to V. Identifiers in the form of elements of conic sections (elements of ellipses and hyperbolas) are provided at boundaries of transverse sections and boundaries of longitudinal sections.

Sheet material can be produced as a single-layer or multi-layer material. For more information the drawings depict a double-layer deformed sheet material. The sheet material comprises a metal sheet 1 and a coating 2. In general, the sheet material can be three-layer, five-layer, etc (multi-layered).

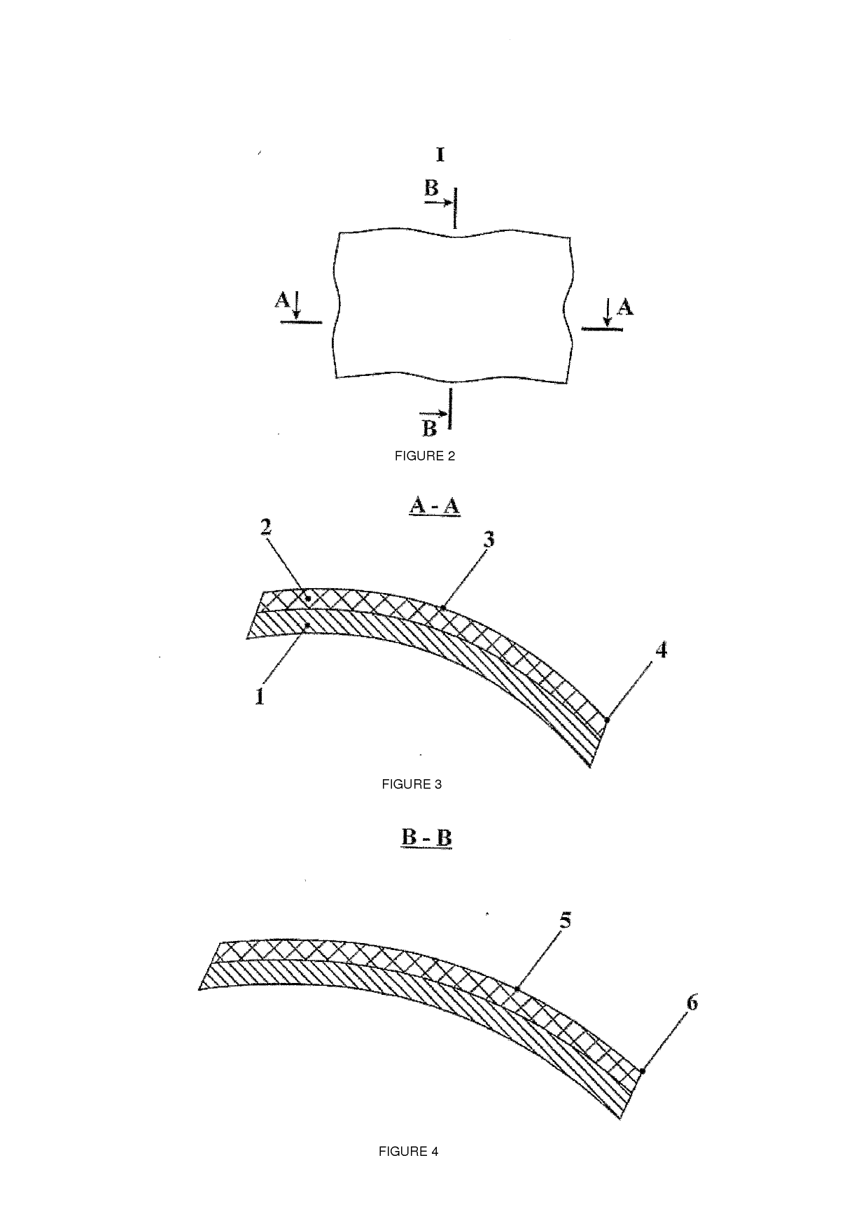

Detail drawing I (FIG. 2) shows transverse section B-B and longitudinal section A-A of a deformed sheet material. The boundary of longitudinal section A-A (FIG. 3) is formed, at the segment between points 3 and 4, as an element of ellipse. The boundary of transverse section B-B (FIG. 4) is formed, at the segment between points 5 and 6, as an element of ellipse. The ellipse element between points 3 and 4 is longer in length than the ellipse element between points 5 and 6. The difference in length of these elements is 10%. Moreover, the ellipse elements have different eccentricities and focal parameters.

Sections B-B, D-D, J-J, G-G, K-K are turned around 90° on the Figures.

Eccentricity is a dimensionless value. Focal parameters and lengths of curve elements are given in millimeters (mm) in the application.

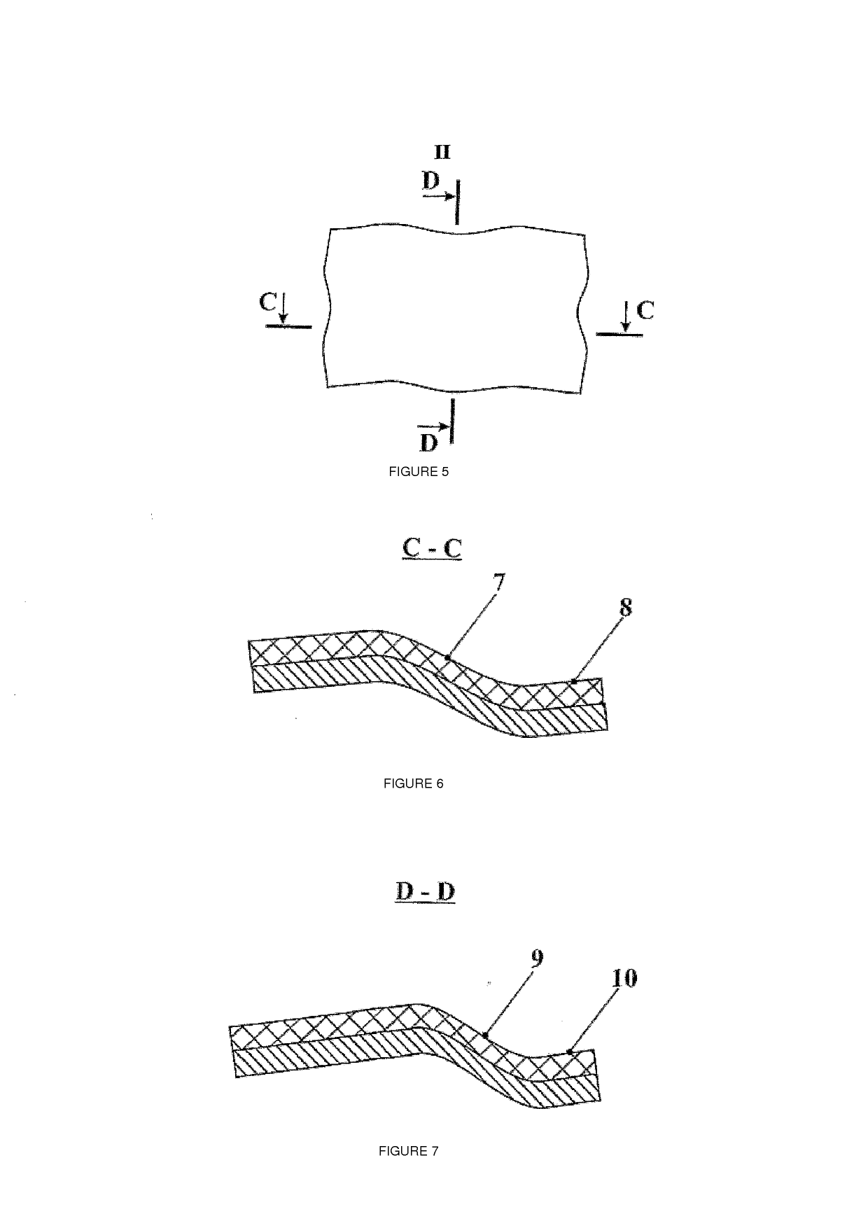

Detail drawing II (see FIG. 5) shows transverse section D-D and longitudinal section C-C of a deformed sheet material. The boundary of longitudinal section C-C (see FIG. 6) is formed, at the segment between points 7 and 8, as an element of hyperbola. The boundary of transverse section D-D (see FIG. 7) is formed, at the segment between points 9 and 10, as an element of hyperbola as well. The hyperbola element between points 7 and 8 is longer in length than the hyperbola element between points 9 and 10. The difference in length of these elements is 15%. Moreover, these hyperbola elements have different eccentricities and focal parameters.

Detail drawing III (see FIG. 8) shows transverse section J-J and longitudinal section E-E of a deformed sheet material. The boundary of longitudinal section E-E (see FIG. 9) is formed, at the segment between points 11 and 12, as an element of an ellipse and, at the segment between points 12 and 13, form of an element of an ellipse. The ellipse element between points 11 and 12 is longer in length than an element of ellipse between points 12 and 13. The difference in length of these elements is 20%. Moreover, these ellipse elements have different values of eccentricities and focal parameters.

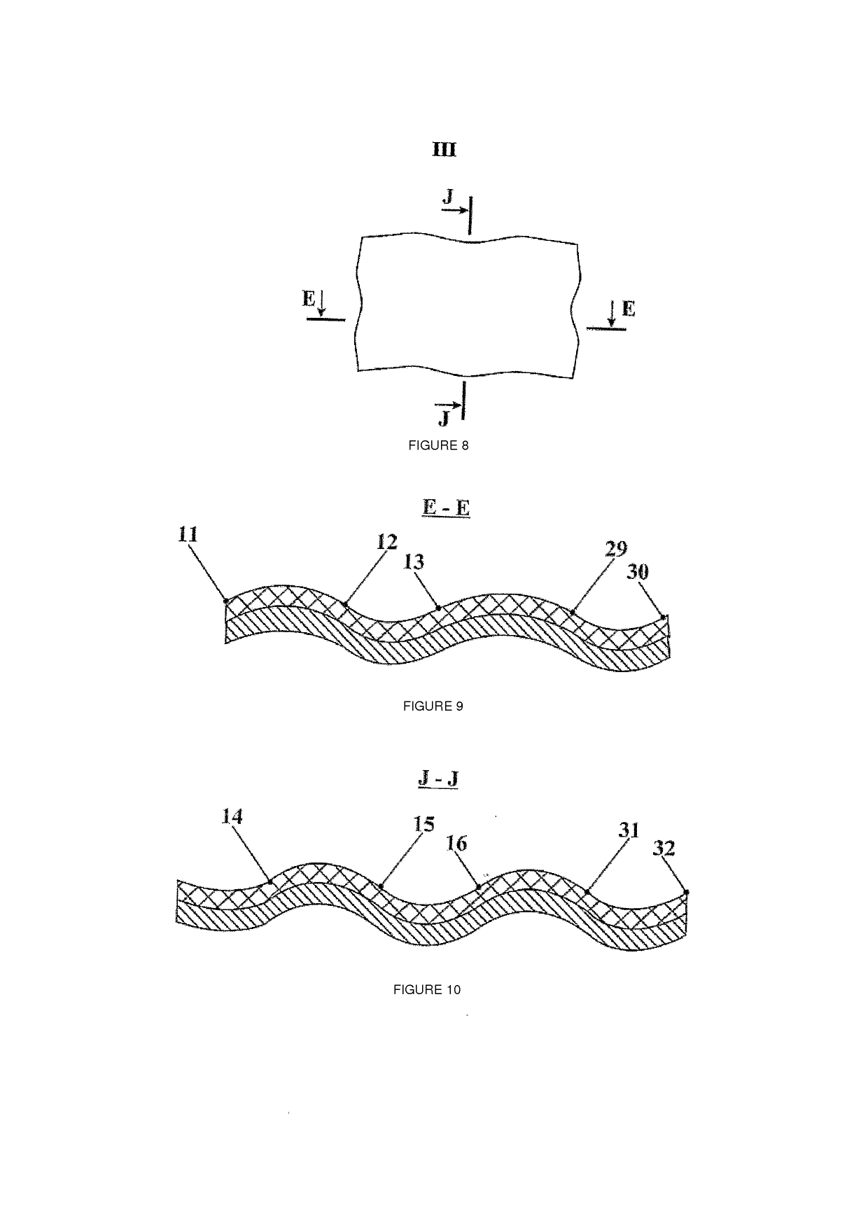

The boundary of transverse section J-J (FIG. 10) is formed, at the segment between points 14 and 15, as an element of ellipse and, at the segment between points 15 and 16, form of an element of ellipse. The ellipse element between points 14 and 15 is longer in length than the ellipse element between points 15 and 16. The difference in length of these elements is 5%. Moreover, these ellipses elements have different values of eccentricities and focal parameters.

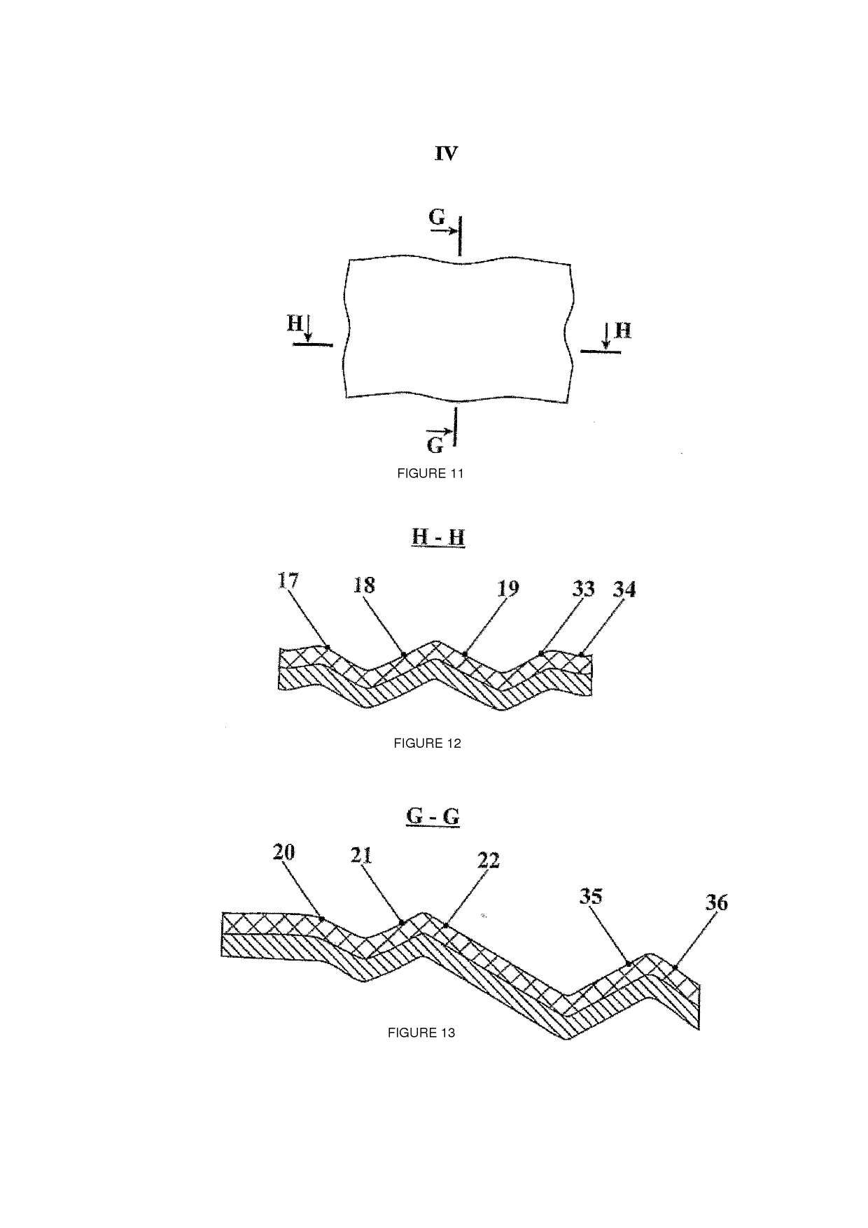

Detail drawing IV (see FIG. 11) shows transverse section G-G and longitudinal section H-H of a deformed sheet material. The boundary of longitudinal section H-H (see FIG. 12) is formed, at the segment between points 17 and 18, as an element of hyperbola and, at the segment between points 18 and 19, form of an element of hyperbola. The hyperbola element between points 17 and 18 is longer in length than the hyperbola element between points 18 and 19. The difference in length of these elements is 25%. Moreover, these elements of hyperbolas have different values eccentricities and focal parameters.

The boundary of transverse section G-G (see FIG. 13) is formed, at the segment between points 20 and 21, as an element of hyperbola and, at the segment between points 21 and 22, form of an element of hyperbola. The hyperbola element between points 20 and 21 is longer in length than the hyperbola element between points 21 and 22. The difference in length of these elements is 30%. Moreover, these hyperbolas elements have different values of eccentricities and focal parameters.

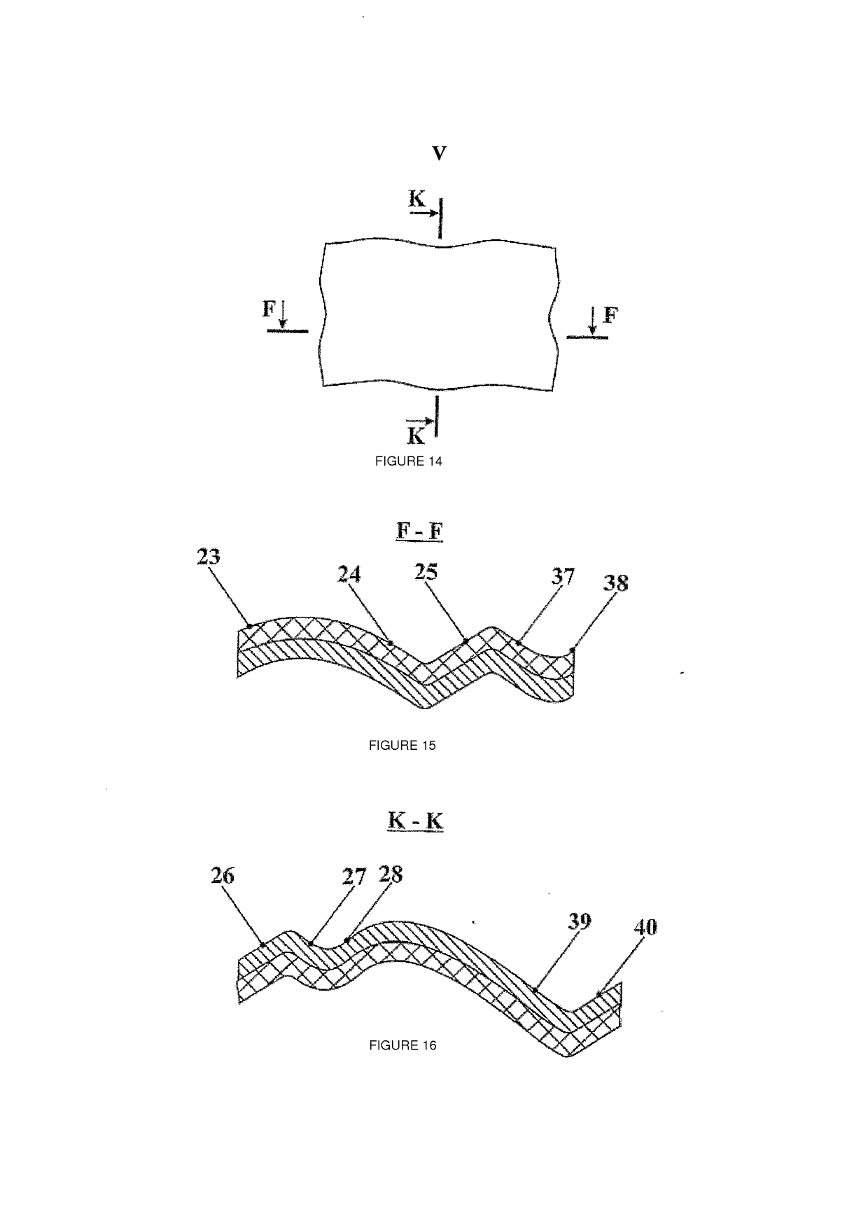

Detail drawing V (see FIG. 14) shows transverse section K-K and longitudinal section F-F of a deformed sheet material. The boundary of longitudinal section F-F (see FIG. 15) is formed, at the segment between points 23 and 24, as an element of ellipse and, at the segment between points 24 and 25, form of an element of hyperbola. The hyperbola element between points 24 and 25 is shorter in length than the ellipse element between points 23 and 24. The difference in length of these elements is 100%.

The boundary of transverse section K-K (see FIG. 16) is formed, at the segment between points 26 and 27, as an element of hyperbola and, at the segment between points 27 and 28, form of an element of ellipse. The hyperbola element between points 26 and 27 is longer in length than the ellipse element between points 27 and 28. The difference in length of these elements is 5%.

The above segments of transverse section boundaries and segments of longitudinal section boundaries intersect.

A sheet material is made so that in the longitudinal section (see FIG. 9) it further comprises a segment of the section boundary formed be two different length elements of various ellipses (between points 13 and 29, 29 and 30) having different values of eccentricities and focal parameters.

A sheet material is made so that in the transverse section (see FIG. 10) it further comprises a segment of the section boundary formed by two different length elements of various ellipses (between points 16 and 31, 31 and 32) having different values of eccentricity and focal parameters.

A sheet material is made so that in the longitudinal section (see FIG. 12) it further comprises a segment of the section boundary formed by two different length elements of various hyperbolas (between points 19 and 33, 33 and 34) having different values of eccentricity and focal parameters.

A sheet material is made so that in the transverse section (see FIG. 13) further comprises a segment of the section boundary formed by two different length elements of various hyperbolas (between points 22 and 35, 35 and 36) having different values of eccentricity and focal parameters.

A sheet material is made so that in the longitudinal section (see FIG. 15) it further comprises a segment of the section boundary formed by different length elements of hyperbola (between points 25 and 37) and ellipse (between points 37 and 38).

A sheet material is made so that in the transverse section (see FIG. 16) it further comprises a segment of the section boundary formed by different length elements of hyperbola (between points 39 and 40) and ellipse (between points 28 and 39).

A mould for manufacture of deformed sheet materials (such as car fenders) is manufactured, for example, by stamping. Shape of the mould defines the shape of sheet material to be deformed with a press. The mould comprises, in the transverse section, a segment of the boundary formed as a conic section element or elements (elements of ellipses and/or hyperbolas). Transverse section of the mould coincides with transverse section of the deformed sheet material.

Furthermore, the mould comprises, in the longitudinal section, a segment of the boundary formed as a conic section element or elements (elements of ellipses and/or hyperbolas). Longitudinal section of the mould coincides with longitudinal section of the deformed sheet material.

Specific embodiments of the invention as applied to a car fender made of deformed sheet material will be described below.

A deformed sheet material is made so that the boundary of the longitudinal section (see FIG. 3) is formed, at the segment between points 3 and 4, as an ellipse element of 10 mm length with the eccentricity of 0.8 and focal parameter of 2 mm. The boundary of the transverse section (see FIG. 4) is formed, at the segment between points 5 and 6, as an ellipse element of 11 mm length with the eccentricity of 0.5 and focal parameter of 40 mm. The segment between points 3 and 4 is bent outwards of the sheet material. The segment between points 5 and 6 is bent outwards of the sheet material.

A deformed sheet material is made so that the boundary of the longitudinal section (see FIG. 6) is formed, at the segment between points 7 and 8, as a hyperbola element of 20 mm length with the eccentricity of 35 and focal parameter of 4 mm. The boundary of the transverse section (see FIG. 7) is formed, at the segment between points 9 and 10, as a hyperbola element of 23 mm length with the eccentricity of 25 and focal parameter of 5 mm. The segment between points 7 and 8 is bent inwards of the sheet material. The segment between points 9 and 10 is bent inwards of the sheet material.

A deformed sheet material is made so that the boundary of the longitudinal section (see FIG. 9) is formed, at the segment between points 11 and 12, 12 and 13, by elements of different length ellipses of 10 mm and 12 mm lengths with the eccentricities of 0.85 and 0.98 and focal parameters of 2 mm and 3 mm, respectively. The boundary of the transverse section (see FIG. 10) is formed, at the segment between points 14 and 15, 15 and 16, by elements of various ellipses of 11 mm and 11.55 mm lengths with the eccentricities of 0.5 and 0.45 and focal parameters of 40 mm and 60 mm, respectively.

A deformed sheet material is made so that the boundary of the longitudinal section (see FIG. 12) is formed, at the segment between points 17 and 18, 18 and 19, by elements of various hyperbolas of 15 mm and 18.75 mm lengths with the eccentricities of 5.85 and 7.98 and focal parameters of 12 mm and 35 mm, respectively. The boundaries of the transverse section (see FIG. 13) are formed, at the segment between points 20 and 21, 21 and 22, as elements of various hyperbolas of 28 mm and 21.55 lengths with the eccentricities of 6.5 and 2.45 and focal parameters of 40 mm and 20 mm, respectively.

A deformed sheet material is made so that the boundary of the longitudinal section (see FIG. 15) is formed, at the segment between points 23 and 24, 24 and 25, by elements of ellipse and hyperbola of 50 mm and 25 mm lengths with the eccentricities of 0.85 and 9.99 and focal parameters of 90 mm and 25 mm, respectively. The boundary of the transverse section (see FIG. 16) is formed, at the segment between points 26 and 27, 27 and 28, by elements of hyperbola and ellipse of 28 mm and 29.4 mm lengths with the eccentricities of 9.5 and 0.45 and focal parameters of 20 mm and 10 mm, respectively.

Further embodiments of the invention may include the following.

A sheet material is made so that the boundary of the transverse section is formed, at one of its segments, by at least two different length elements of different ellipses (with focal parameters 10 mm and 100 mm), with the ratio of the length of the larger element of ellipse to the length of the smaller element of ellipse being in the range from 1.001 to 1000. For example, the length of the larger element of ellipse may be 1.001 mm, and the length of the smaller element of ellipse may be 1.000 mm. Then the ratio of the length of the larger element of ellipse to the length of the smaller element of ellipse is 1.001. The length of the larger element of ellipse may be 1000 mm, and the length of the smaller element of ellipse may be 1.000 mm Then the ratio of the length of the larger element of ellipse to the length of the smaller element of ellipse is 1000.

A sheet material may be made so that the transverse section boundary is formed, in at least one of the segments, by at least two different length elements of ellipses with different values of eccentricity (for example, with the values 0.000000999 and 0.999 or with values 0.999 and 0.998). Then the ratio of the larger value of eccentricity of the ellipse to the smaller value of eccentricity of the ellipse is 1000000 and 1.001, respectively.

The transverse section boundary of a sheet material can be formed, in one of its segments, by at least two different length elements of different hyperbolas, with the ratio of the length of the larger element of hyperbola to the length of the smaller element of hyperbola being from 1.001 to 1000. For example, the length of the larger element of hyperbola may be 1.001 mm and the length of the smaller element of hyperbola may be 1.000 mm Then the ratio of the larger element of hyperbola to the length of the smaller element of hyperbola is 1.001. The length of the larger element of hyperbola may be 1000 mm, and the length of the smaller element of hyperbola may be 1.000 mm. Then the ratio of the length of the larger element of hyperbola to the length of the smaller element of hyperbola is 1000.

The length of the segment of the boundary of (longitudinal or transverse) section may be “1”. And the length of the boundary of the section may be “L. Then “1” is determined according to the formula:

0.0001L≦1<0.99L.

The length of the element of a conic section (ellipse or hyperbola) at longitudinal or transverse section may be “k”. Then “k” is determined according to the formula:

0.0001L≦k<0.99L.

Sheet material may be made so that at a section (longitudinal or transverse), the transverse section boundary may be formed, in at least one of the segments, by at least two different length elements of hyperbolas with different values of eccentricity (e.g. with values 1.1 and 1.0989, or with values 1.1 and 1100000). Then the ratio of the larger value of eccentricity of hyperbola to the smaller value of eccentricity of hyperbola is 1.001 and 1000000, respectively.

Sheet material may be made so that at a section (longitudinal or transverse) the ratio of the larger value of eccentricity of ellipse to the lower value of eccentricity of ellipse is 1.001, i.e. the value of the smaller eccentricity is 0.29, and the value of the larger eccentricity is 0.29029. Seamless connection of the elements is provided at that.

Sheet material may be made so that at a section (longitudinal or transverse) the ratio of the larger value of eccentricity of ellipse to the smaller value of eccentricity of ellipse is 100, i.e. the larger value of eccentricity is 0.29, and the smaller value of eccentricity is 0.0029. Seamless connection of elements is provided at that.

Sheet material may be made so that at a section (longitudinal or transverse) the ratio of the larger value of eccentricity of ellipse to the smaller value of eccentricity of ellipse is 1000000, i.e. the value of the larger eccentricity is 0.99, and the value of the smaller eccentricity is 0.00000099.

Sheet material may be made so that at a section (longitudinal or transverse) the ratio of the length the larger element of hyperbola to the length of the smaller element of hyperbola is 1.001, i.e. the length of the larger element is 1.001 mm and the length of the smaller element is 1 mm.

Sheet material may be made so that at a section (longitudinal or transverse) the ratio of the length the larger element of hyperbola to the length of the smaller element of hyperbola is 10, i.e. the length of the larger element is 10 mm and the length of the smaller element is 1 mm.

Sheet material may be made so that at a section (longitudinal or transverse) the ratio of the length the larger element of hyperbola to the length of the smaller element of hyperbola is 100, i.e. the length of the larger element is 100 mm and that of the smaller element is 1 mm.

Sheet material may be made so that at a section (longitudinal or transverse) the ratio of the length of the larger element of hyperbola to the length of the smaller element of hyperbola is 1000, i.e. the length of the larger element is 1000 mm and that of the smaller element is 1 mm.

Sheet material may be made so that at a section (longitudinal or transverse) the ratio of the larger value of eccentricity of hyperbola to the smaller value of eccentricity of hyperbola is 1.001, i.e. the smaller value of eccentricity is 10, and the larger value is 10.01.

Sheet material in a section (longitudinal or transverse) can be made so that the ratio of the larger value of eccentricity of hyperbola to the smaller value of eccentricity of hyperbola is 10, i.e. the smaller value of eccentricity is 10, and the larger value is 100.

Sheet material in a section (longitudinal or transverse) can be made so that the ratio of the larger value of eccentricity of hyperbola to the smaller value of eccentricity of hyperbola is 100, i.e. the smaller value of eccentricity is 100, and the larger value is 100000.

Sheet material in a section (longitudinal or transverse) can be made so that the ratio of the larger value of eccentricity of hyperbola to the lower value of eccentricity of hyperbola is 10000, i.e. the smaller value of eccentricity is 10, and the larger value is 1000000. Seamless connection of elements is provided at that.

Sheet material in a section (longitudinal or transverse) can be made so that the ratio of the larger value of eccentricity of hyperbola to the smaller value of eccentricity of hyperbola is 1000000, that is the smaller value of eccentricity is 10, and the larger value is 10000000.

Presence of difference in the above parameters allows for efficient identification of sheet materials.

All said above can be briefly described as follows: a deformed sheet material is made so that predetermined crossing segments of boundaries of its transverse and longitudinal sections are formed by ellipse elements with different characteristics and hyperbola elements with different characteristics.

The invention is utilized in a way as follows.

Location of segments on section boundaries, number of elements, length of elements, and parameters of curves (eccentricity, focal parameter) are identifiers of the sheet material manufacturer. Moreover, information about properties of the sheet material, importer and exporter, may be encoded with the aid of the above segments on section boundaries of the sheet material.

After manufacture of the sheet material, prior to its intended use, identification is performed.

According to research in the field of recognition and identification of curves, a curve lying in a plane (or at a section) may be divided into segments so that every segment is (with 0.1% accuracy for three-axis machines like CRYST-APEX C544, CRYST-APEX C574, CRYST-APEX C9166 etc.) approximated by a straight line or a second-order curve (hyperbola, parabola, ellipse, circle).

Identification of the shape of deformed sheet material is performed based on measurements of coordinates of the boundary of transverse and longitudinal section. Every segment of the section boundary is approximated by a second-order curve by N points with coordinates: xᵢ, yᵢ, where i=1, . . . N. Measurements of coordinates of section points are made using a measuring device, in particular, a three-axis measuring machine. For example, three-axis measuring machines CRYST-APEX C544, CRYST-APEX C574, CRYST-APEX C9166, CRYST-APEX C123010 with 1 to 3 μm measurement error, or UPMC 850 by Zeiss with 1 to 1.5 μm measurement error may be used for this purpose.

Determination of the geometrical shape of the sheet material is performed based on the complex of measurements of orthogonal coordinates of a profile (section boundaries) of the sheet material, Xᵢ, Yᵢ, i=1, . . . N, where N is the number of measurements. Identification should result in the mathematical representation of the section boundary (profile) of the sheet material, segments of the section boundary (profile) serving as identifiers and being second-order curves. Measurements of coordinates of points on the section boundary (profile) are performed using a coordinate measuring machine with a high dimensional resolution (and accuracy, accordingly), for example, from 100 to 500 dots per millimeter. Measurement error and natural roughness shall be accounted for in algorithms for processing measurements data.

Algorithm for identification of sheet material comprises the following steps:

1. Smoothing of measurements of coordinates of the curve of (transverse or longitudinal) section profile of the sheet material (21).

Smoothing is carried out in order to derive estimation of mean of the section profile of the sheet material. Estimation of mean (mean value) of the profile is calculated according to the formulas:

$${m}_{h} ( x ) = \frac{{N}^{- 1} {\sum }_{i = 1}^{N} {K}_{h} ( x - {X}_{i} ) {Y}_{i}}{{N}^{- 1} {\sum }_{i = 1}^{N} {K}_{h} ( x - {X}_{i} )}$$

where Kₕ(u) is the Gaussian kernel, h is the scale parameter

$${K}_{h} ( u ) = 2 {( π )}^{- 1 / 2} exp ( \frac{- {u}^{2}}{2} )$$

2. Segment of the profile curve, which is the identifier, is described by the second-order equation (24):

G(x,y)=p₁x²+2p₂xy+p₃y²+2p₄x+2p₅y+1=0

To obtain estimation of parameters of second-order curve a, b, c, d, e, it is necessary to solve a system of N equations derived from the results of measurement of orthogonal coordinates of profile Xᵢ, Yᵢ i=1, . . . N, taking the form (22):

Ap=b,

where matrix A=[q₁, q₂, . . . q_{N}]^{T}, vector p=[p₁, p₂, p₃, p₄, p₅]^{T}, column vector qᵢ=[X²ᵢ, 2XᵢYᵢ, Y²ᵢ, 2Xᵢ, 2Yᵢ]]^{T}, vector b=[−1, −1, . . . −1] of N dimension.

Solution of the system of equations using the least-squares technique with QR-factorization of matrix A=QR is written as (23):

p=R⁻¹Q^{T}b

3. Invariants of second-order curves are calculated (24):

$$I = {p}_{1} + {p}_{3}$$

$$D = \vert \begin{matrix}{p}_{1} & {p}_{2} \\ {p}_{2} & {p}_{3}\end{matrix} \vert$$

$$C = \vert \begin{matrix}{p}_{1} & {p}_{2} & {p}_{4} \\ {p}_{2} & {p}_{3} & {p}_{5} \\ {p}_{4} & {p}_{5} & 1\end{matrix} \vert$$

Shape of the profile curve segment is determined depending on the fulfillment of the following conditions:

D>0 and

$$\frac{C}{I} < 0$$

—the segment of the profile curve is ellipse;

D<0—the segment of the profile curve is hyperbola;

D=0—the segment of the profile curve is parabola;

D>0 and

$$\frac{C}{I} < 0$$

and I²=4D—the segment of the profile curve is circle.

Then, using known transformations (24), consisting in introduction of a new system of coordinates, the general equation of the second-order curve can be reduced to standard or canonical form. Canonical equation of any non-degenerate second-order curve can be reduced to the form (24):

y²=2px−(1−e²)x²

In this equation, “e” means eccentricity, and “p” means focal parameter.

Length of arc of the curve is:

$$s = {\int }_{a}^{b} \sqrt{1 + {y}^{′2}} d x$$

where y′ is the first-order derivative of the function describing the arc of the curve in the Cartesian system, x=a and x=b are x-coordinates of points between which the length is determined.

This identification process takes minutes. In case the element that has been recognized in the curve is not the sought element, but any other curve, for example, parabola, the conclusion shall be made that the sheet material is counterfeit. In general, any N-order curve can be used as the manufacturer's identifier, however, use of ellipse and hyperbola specifically is the most effective due to the fact that such curves have been known and thoroughly studied long ago. Values of eccentricity of such curves are determined in ranges, not unit values as with circles or parabolas.

A number of specific examples presented below demonstrate introduction of an identifier into a sheet material when it is manufactured at factory A, and its identification. Notation of the factory is arbitrary.

1. When producing a deformed sheet material (deformation was carried out under a press), the manufacturer made a segment of the boundary of a certain transverse section in a predetermined place in the form of two elements of different curves, in particular, hyperbolas.

The manufacturer declared the following characteristics of elements of the curves:

TABLE 1

| | Eccentricity of | Focal parameter of | Length of hyperbola |
|---|---|---|---|
| Part No. | hyperbola | hyperbola, mm | element, mm |
| 1 | 5.414 | 0.769 * 10³ | 181 |
| | 12.709 | 0.828 * 10³ | 128 |

The manufacturer stated that inaccuracy in determination of all these parameters may not exceed 5%.

In the process of identification performed at the same factory measurements were made at UPMC-850 coordinate measuring machine; measurement accuracy defined as a maximum measurement error for the confidence probability of 0.95 was calculated using the formula:

$$u 95 = ( 1.7 + \frac{L}{300} ) mkm ,$$

where L is the measured dimension, mm

Recognition of curves was performed as described above. Measurements were carried out in the area where the identifier was introduced.

Identification results are shown in Table below.

TABLE 2

| | Eccentricity of | Focal parameter of | Length of hyperbola |
|---|---|---|---|
| Part No. | hyperbola | hyperbola, mm | element, mm |
| 1 | 5.3 | 0.761 * 10³ | 181* |
| | 12.5 | 0.824 * 10³ | 128 |

*lengths of desired elements of hyperbolas were set equal to the lengths of identifier elements set by Factory A.

Measurement error in identification of parameters of the hyperbolas does not exceed 5%.

Therefore, the sheet material has been identified, and it has been defined that Factory A is the manufacturer.

2. When producing the deformed sheet material, the manufacturer made a segment of the boundary of a certain transverse section in a predetermined place in the form of two elements of different curves.

The manufacturer declared the following characteristics of elements of the curves:

TABLE 3

| | Eccentricity of | Focal parameter of | Length of hyperbola |
|---|---|---|---|
| Part No. | hyperbola | hyperbola, mm | element, mm |
| 2 | 9.0 | 1.06 * 10³ | 164 |
| | 11.0 | 1.08 * 10³ | 158 |

The manufacturer stated that measurement error in determination of all these parameters may not exceed 5%.

In the process of identification performed at the same factory measurements were made at UPMC-850 coordinate measuring machine; measurement accuracy defined as a maximum measurement error for the confidence probability of 0.95 was calculated using the formula:

$$u 95 = ( 1.7 + \frac{L}{300} ) mkm ,$$

where L is the measured dimension, mm

Recognition of curves was performed as described above. Measurements were carried out in the area where the identifier was introduced.

Identification results are shown in Table below.

TABLE 4

| | Eccentricity of | Focal parameter of | Length of hyperbola |
|---|---|---|---|
| Part No. | hyperbola | hyperbola, mm | element, mm |
| 2 | 9.005 | 1.058 * 10³ | 164 |
| | 11.086 | 1.081 * 10³ | 158 |

Measurement error in identification of parameters of the hyperbolas does not exceed 5%.

Therefore, the sheet material has been identified, and it has been defined that Factory A is the manufacturer.

3. When producing the deformed sheet material under pressure, the manufacturer made a segment of the boundary of a certain transverse section in a predetermined place in the form of two elements of different curves.

The manufacturer declared the following characteristics of elements of the curves:

TABLE 5

| | Eccentricity of | Focal parameter of | Length of hyperbola |
|---|---|---|---|
| Part No. | hyperbola | hyperbola, mm | element, mm |
| 3 | 5.426 | 0.657 * 10³ | 182 |
| | 4.928 | 0.704 * 10³ | 230 |

The manufacturer stated that measurement error in determination of all these parameters may not exceed 5%.

In the process of identification performed at the same factory measurements were made at UPMC-850 coordinate measuring machine; measurement accuracy defined as a maximum measurement error for the confidence probability of 0.95 was calculated using the formula:

$$u 95 = ( 1.7 + \frac{L}{300} ) mkm ,$$

where L is the measured dimension, mm

Recognition of curves was performed as described above. Measurements were carried out in the area where the identifier was introduced.

Identification results are shown in Table below.

TABLE 6

| | Eccentricity of | Focal parameter of | Length of hyperbola |
|---|---|---|---|
| Part No. | hyperbola | hyperbola, mm | element, mm |
| 3 | 5.42 | 0.653 * 10³ | 182 |
| | 4.92 | 0.700 * 10³ | 230 |

Measurement error in identification of parameters of the hyperbolas does not exceed 5%.

Therefore, the sheet material has been identified, and it has been defined that Factory A is the manufacturer.

4. When producing the deformed sheet material under pressure, the manufacturer made a segment of the boundary of a certain transverse section in a predetermined place in the form of two elements of different curves.

The manufacturer declared the following characteristics of elements of the curves:

TABLE 7

| | Eccentricity of | Focal parameter of | Length of hyperbola |
|---|---|---|---|
| Part No. | hyperbola | hyperbola, mm | element, mm |
| 4 | 5.041 | 0.750 * 10³ | 158 |
| | 7.879 | 0.791 * 10³ | 147 |

The manufacturer stated that measurement error in determination of all these parameters may not exceed 5%.

In the process of identification performed at the same factory measurements were made at UPMC-850 coordinate measuring machine; measurement accuracy defined as a maximum measurement error for the confidence probability of 0.95 was calculated using the formula:

$$u 95 = ( 1.7 + \frac{L}{300} ) mkm ,$$

where L is the measured dimension, mm

Recognition of curves was performed as described above. Measurements were carried out in the area where the identifier was introduced.

Identification results are shown in Table below.

TABLE 8

| | Eccentricity of | Focal parameter of | Length of hyperbola |
|---|---|---|---|
| Part No. | hyperbola | hyperbola, mm | element, mm |
| 4 | 5.04 | 0.77 * 10³ | 158 |
| | 7.875 | 0.79 * 10³ | 147 |

Measurement error in identification of parameters of the hyperbolas does not exceed 5%.

Therefore, the sheet material has been identified, and it has been defined that Factory A is the manufacturer.

5. When producing the deformed sheet material under pressure, the manufacturer made a segment of the boundary of a certain transverse section in a predetermined place in the form of two elements of different curves.

The manufacturer declared the following characteristics of elements of the curves:

TABLE 9

| | Eccentricity of | Focal parameter of | Length of hyperbola |
|---|---|---|---|
| Part No. | hyperbola | hyperbola, mm | element, mm |
| 5 | 7.324 | 0.836 * 10³ | 148 |
| | 10.492 | 0.686 * 10³ | 157 |

The manufacturer stated that measurement error in determination of all these parameters may not exceed 5%.

In the process of identification performed at the same factory measurements were made at UPMC-850 coordinate measuring machine; measurement accuracy defined as a maximum measurement error for the confidence probability of 0.95 was calculated using the formula:

$$u 95 = ( 1.7 + \frac{L}{300} ) mkm ,$$

where L is the measured dimension, mm.

Recognition of curves was performed as described above. Measurements were carried out in the area where the identifier was introduced.

Identification results are shown in the table below.

TABLE 10

| | Eccentricity of | Focal parameter of | Length of hyperbola |
|---|---|---|---|
| Part No. | hyperbola | hyperbola, mm | element, mm |
| 5 | 7.321 | 0.835 * 10³ | 148 |
| | 10.488 | 0.685 * 10³ | 157 |

Measurement error in identification of parameters of the hyperbolas does not exceed 5%.

Therefore, the sheet material has been identified, and it has been defined that Factory A is the manufacturer.

6. When producing the deformed sheet material under pressure, the manufacturer made a segment of the boundary of a certain transverse section in a predetermined place in the form of two elements of different curves.

The manufacturer declared the following characteristics of elements of the curves:

TABLE 11

| | Eccentricity of | Focal parameter of | Length of hyperbola |
|---|---|---|---|
| Part No. | hyperbola | hyperbola, mm | element, mm |
| 6 | 4.623 | 0.661 * 10³ | 155.85 |
| | 7.662 | 0.703 * 10³ | 145.76 |

The manufacturer indicated that the error in determination of all these parameters must not exceed 5%.

In the process of identification performed at the same factory measurements were made at UPMC-850 coordinate measuring machine; measurement accuracy defined as a maximum measurement error for the confidence probability of 0.95 was calculated using the formula:

$$u 95 = ( 1.7 + \frac{L}{300} ) mkm ,$$

where L is the measured dimension, mm

Recognition of curves was performed as described above. Measurements were carried out in the area where the identifier was introduced.

Identification results are shown in the table below.

TABLE 12

| | Eccentricity of | Focal parameter of | Length of hyperbola |
|---|---|---|---|
| Part No. | hyperbola | hyperbola, mm | element, mm |
| 6 | 4.627 | 0.663 * 10³ | 155.85 |
| | 7.665 | 0.701 * 10³ | 145.76 |

Measurement error in identification of parameters of the hyperbolas does not exceed 5%.

Therefore, the sheet material has been identified, and it has been defined that Factory A is the manufacturer.

In Examples 1 to 5 lengths of elements were defined in mm. In Example 6 lengths of elements were defined accurate to 10 μm.

Every plant or factory legitimately producing sheet materials shall be assigned a unique combination of elements of ellipses and/or hyperbolas in the place defined for the identifier at the transverse section boundary.

Moreover, use of the invention in the manufacture of sheet materials with irregularly shaped transverse sections shall considerably simplify the production process owing to the reduction of types of used curves to two types: ellipse and hyperbola. Simplification of the process is achieved mainly due to simplification of operations of computer-controlled machines.

Surface area of the inventive sheet materials will be extended as compared to the closest prior art. Consequently, heat exchange of the sheet material of the invention with the environment will increase.

The sheet material of the invention exhibits higher heat conductivity in places of thinning

The process of disposal of sheet materials will be also simplified due to the fact that, when manufacturing sheet materials according to the invention, structural orientation of strength properties of the sheet materials is provided in longitudinal and transverse section. In the process of disposal, sheet materials are oriented in a press so that the compressive effect of the press occurs in a plane with the lowest compressive load resistance of the sheet material body. Action of force is directed so that the longitudinal and transverse sections offer minimal compression resistance. Experimental studies conducted with test samples of the sheet material of the invention have showed that breakage of the sheet material under compression takes place at weakened locations.

Therefore, the object of the invention has been attained and the declared technical advantages have been achieved.

### REFERENCES CITED

1. Abstract of RU Pat. No. 2140678, Ceramic Capacitor, published 27 Oct. 1999, Int.C1. H01G 4/12.
2. Abstract of RU Pat. No. 2144149, Layered Washer, published 10 Jan. 2000, Int.C1. F16B 43/00.
3. Abstract of RU Pat. No. 2139816, Metal Reservoir, published 20 Oct. 1999, Int.C1. B65D 1/00.
4. Abstract of RU Pat. No. 2139819, Layered Vessel, published 20 Oct. 1999, Int.C1. B65 D1/02.
5. Abstract of RU Pat. No. 2136412, Tubular Laminated Construction Material, published 10 Sep. 1999, Int.C1. B21B 17/00.
6. Abstract of RU Pat. No. 2266851, Package, published 27 Dec. 2005, Int.C1. B65D 1/00.
7. Abstract of RU Pat. No. 2143614, Layered Stud, published 27 Dec. 1999, Int.C1. F16B 35/00.
8. Abstract of RU Pat. No. 2143610, Layered Washer, published 10 Jan. 2000, Int.C1. F16B 43/00.
9. Abstract of RU Pat. No. 2144149, Layered Screw, published 27 Dec. 1999, Int.C1. F16B 25/00.
10. Abstract of RU Pat. No. 2143608, Layered Rivet, published 27 Dec. 1999, Int.C1. F16B 19/04.
11. Abstract of RU Pat. No. 2144146, Layered Nut, published 10 Jan. 2000, Int.C1. F16B 37/00.
12. Abstract of RU Pat. No. 2144632, Washer, published 20 Jan. 2000, Int.C1. F16B 43/00.
13. Abstract of RU Pat. No. 2143365, Ship Stringer, published 27 Dec. 1999, Int.C1. B36B 3/28.
14. Abstract of RU Pat. No. 2143364, Ship Frame, published 27 Dec. 1999, Int.C1. B36B 3/28.
15. Abstract of RU Pat. No. 2143363, Layered Plating of Ship, published 27 Dec. 1999, Int.C1.B36B 3/20.
16. Abstract of RU Pat. No. 2143362, Ship Plating, published 27 Dec. 1999, Int.C1. B36B 3/16.
17. Abstract of RU Pat. No. 2143379, Ship Beam, published 27 Dec. 1999, Int.C1. B64C 1/06.
18. Abstract of RU Pat. No. 2143380, Aircraft Skin, published 27 Dec. 1999, Int.C1. B64C 1/14.
19. Abstract of RU Pat. No. 2144482, Layered Aircraft Skin, published 20 Jan. 2000, Int.C1. B64C 1/12.
20. Abstract of RU Pat. No. 2144487, Layered Aircraft Stringer, published 20 Jan. 2000, Int.C1. B64C 3/18.
21. W. Hardle. Applied nonparametric regression. Cambridge University Press. Cambridge, 1990.
22. Z. Zhang, Parameter Estimation Techniques: A Tutorial with Application to Conic Fitting, International Journal of Image and Vision Computing, Vol. 15, No. 1, pages 59-76, January 1997.
23. J. Demmel Applied Numerical Linear Algebra. Society for Industrial and Applied Mathematics. Philadelphia, 1997.
24. G. Korn, M. Korn. Mathematical Handbook for Scientist and Engineers. McGraw-Hill Book Company. New York, 1968.

1. A deformed sheet material made so that the boundary of its transverse section, in at least one segment, is formed as an element of a conic section and the boundary of its longitudinal section, in at least one segment, is formed as an element of a conic section, characterized in that said segment of the transverse section boundary of the deformed sheet material and said segment of the longitudinal section boundary are selected from the group including;
(a) said segment of the transverse section boundary of the deformed sheet material and said segment of the longitudinal section boundary are formed as different length elements of different ellipses with different values of eccentricities and focal parameters, and said segment of the transverse section boundary and said segment of the longitudinal section boundary intersect;
(b) said segment of the transverse section boundary of the deformed sheet material and said segment of the longitudinal section boundary of the elements are formed as different length elements of different hyperbolas with different values of eccentricities and focal parameters, and said segment of the transverse section boundary and said segment of the longitudinal section boundary intersect;
(c) said transverse section boundary of the deformed sheet material further comprises a segment formed as different length elements of different ellipses with different values of eccentricities and focal parameters, and said longitudinal section boundary of the deformed sheet material further comprises a segment formed as different length elements of different ellipses with different values of eccentricities and focal parameters, and said segment of the transverse section boundary and said segment of the longitudinal section boundary intersect;
(d) said transverse section boundary of the deformed sheet material further comprises a segment formed as different length elements of different hyperbolas with different values of eccentricities and focal parameters, and said longitudinal section boundary of the deformed sheet material further comprises a segment formed as different length elements of different hyperbolas with different values of eccentricities and focal parameters, and said segment of the transverse section boundary and said segment of the longitudinal section boundary intersect;
(e) said transverse section boundary of the deformed sheet material further comprises a segment formed as different length elements of hyperbola and ellipse, and said longitudinal section boundary of the deformed sheet material further comprises a segment formed as different length elements of hyperbola and ellipse, and said segment of the transverse section boundary and said segment of the longitudinal section boundary intersect.
